(19) United States
(12) Patent Application Publication
(10) Pub. No.: US 2026/0034652 A1
(43) Pub. Date: Feb. 5, 2026

(54) Tool For Removing A Rubber Protector From A Riser Flange

(71) Applicant: Reginald McKnight, El Campo, TX (US)

(72) Inventor: Reginald McKnight, El Campo, TX (US)

(21) Appl. No.: 18/792,887

(22) Filed: Aug. 2, 2024

(51) Int. Cl. B25B 27/14; E21B 17/10

(52) U.S. Cl. CPC B25B 27/14; E21B 17/1042

(57) ABSTRACT

A tool for removing a rubber protector from a riser flange is disclosed. The tool includes a rectangular handle having a first orientation. The tool also includes a rod having a first end that is attached to a midpoint of the rectangular handle. The rod has a second orientation that is perpendicular to the first orientation of the rectangular handle. The rod has a second length that is greater than a first length of the rectangular handle. The tool also include a U-shaped component attached to a second end of the rode. The U-shaped component is configured to grasp at least a portion of the rubber protector. In response to a first force applied to the rectangular handle, the U-shaped component is also configured to apply a second force to the portion of the rubber protector to remove the rubber protector from the riser flange.

### FIELD OF THE DISCLOSURE

The present disclosure is related to a tool, and more particularly, a tool for removing a rubber protector from a riser flange.

### BACKGROUND

A riser flange is a fitting used on floating offshore drilling rigs to create a seal between the ocean floor's wellbore and the drilling equipment above the water's surface. Riser flanges typically include rubber protectors. During construction, prior to lifting a riser flange with a crane, the rubber protectors of the riser flanges need to be removed. However, the rubber protectors may be tight and difficult to remove. In some scenarios, construction crews may use different items, such as screwdrivers, pliers, paint scrappers, etc., to pry the rubber protectors from the riser flanges. However, using the above-mentioned items is time consuming and may also result in damage (e.g., scratches) to the riser flanges.

### SUMMARY

According to one implementation of the present disclosure, a tool for removing a rubber protector from a riser flange is disclosed. The tool includes a rectangular handle having a first orientation. The tool also includes a rod having a first end that is attached to a midpoint of the rectangular handle. The rod has a second orientation that is perpendicular to the first orientation of the rectangular handle. The rod has a second length that is greater than a first length of the rectangular handle. The tool also include a U-shaped component attached to a second end of the rode. The U-shaped component is configured to grasp at least a portion of the rubber protector. In response to a first force applied to the rectangular handle, the U-shaped component is also configured to apply a second force to the portion of the rubber protector to remove the rubber protector from the riser flange.

One advantage of the above-described implementation is efficient removal of the rubber protectors from riser flanges. For example, instead of construction crews exerting large amounts of energy and time attempting to remove the rubber protectors from the riser flanges, the construction crew can use the tool described herein to remove the rubber protectors while exerting a fraction of the energy and in a fraction of the time. Additionally, the features, functions, and advantages that have been described can be achieved independently in various implementations or may be combined in yet other implementations, further details of which are disclosed with reference to the following description and drawings.

### BRIEF DESCRIPTION OF THE DRAWINGS

FIG. 1 is a diagram of a tool that is operable to remove a rubber protector from a riser flange.

FIG. 2 illustrates tools, having different dimensions, that are operable to remove a rubber protector from a riser flange.

FIG. 3 illustrates a diagram of a tool removing a rubber protector from a riser flange.

FIG. 4 illustrates a first step for removing a rubber protector from a riser flange with a tool.

FIG. 5 illustrates a second step for removing a rubber protector from a riser flange with the tool.

### DETAILED DESCRIPTION

Particular embodiments of the present disclosure are described below with reference to the drawings. In the description, common features are designated by common reference numbers throughout the drawings.

The figures and the following description illustrate specific exemplary embodiments. It will be appreciated that those skilled in the art will be able to devise various arrangements that, although not explicitly described or shown herein, embody the principles described herein and are included within the scope of the claims that follow this description. Furthermore, any examples described herein are intended to aid in understanding the principles of the disclosure and are to be construed as being without limitation. As a result, this disclosure is not limited to the specific embodiments or examples described below, but by the claims and their equivalents.

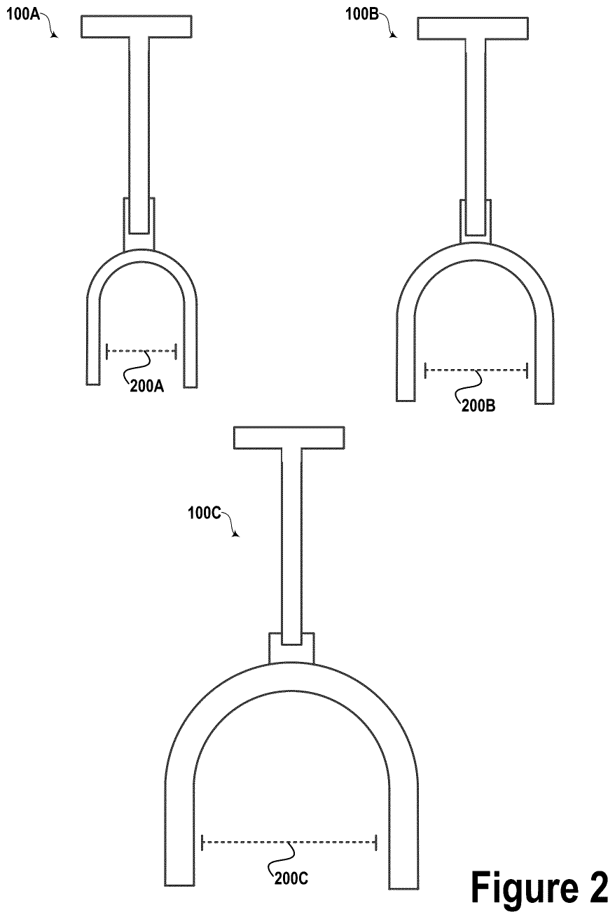

Particular implementations are described herein with reference to the drawings. In the description, common features are designated by common reference numbers throughout the drawings. In some drawings, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter. For example, referring to FIG. 2, multiple tools are illustrated and associated with reference numbers 100A, 100B, and 100C. When referring to a particular one of these tools, such as the tool 100A, the distinguishing letter “A” is used. However, when referring to any arbitrary one of these tools or to these tools as a group, the reference number 100 is used without a distinguishing letter.

As used herein, various terminology is used for the purpose of describing particular implementations only and is not intended to be limiting. For example, the singular forms “a,” “an,” and “the” are intended to include the plural forms as well, unless the context clearly indicates otherwise. Further, the terms “comprise,” “comprises,” and “comprising” are used interchangeably with “include,” “includes,” or “including.” Additionally, the term “wherein” is used interchangeably with the term “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

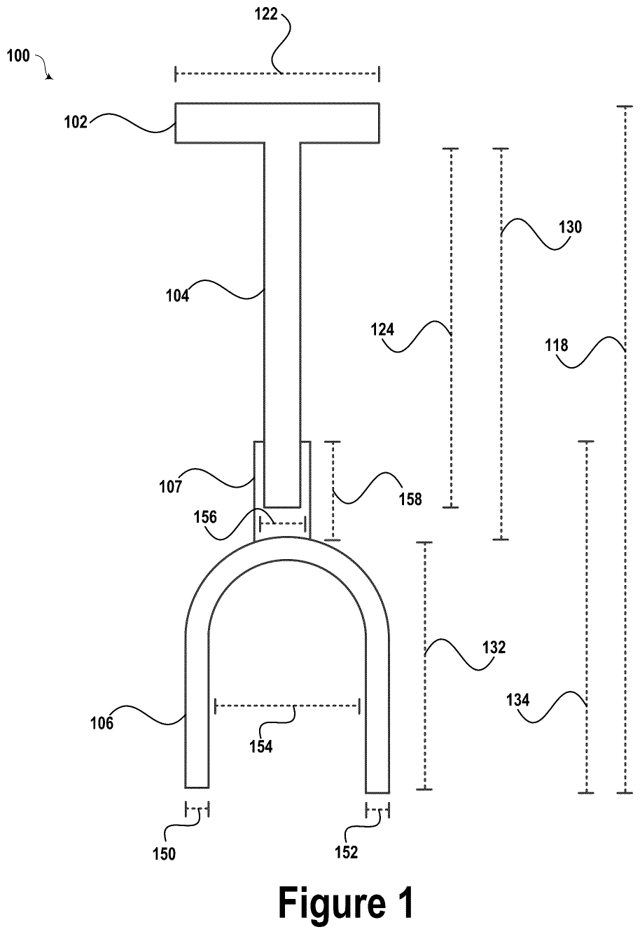

FIG. 1 is a diagram of a tool 100 that is operable to remove a rubber protector from a riser flange.

The tool 100 includes a rectangular handle 102 having a first orientation. For example, as depicted in FIG. 1, the rectangular handle 102 may have a horizontal orientation. In other implementations, the rectangular handle 102 may have a different orientation. As a non-limiting example, the rectangular handle 102 may have a vertical orientation in different implementations. In some implementations, the handle 102 may have a different shape. As non-limiting examples, the handle 102 may be circular, square, etc. In some implementations, the rectangular handle 102 may be comprised of steel or any other sturdy material, such as iron, copper, plastic, etc.

The tool 100 also includes a rod 104 having a first end that is attached to a midpoint of the rectangular handle 102. In some scenarios, the rod 104 may be attached to the rectangular handle 102 via a welding process. In some implementations, the rod 104 may be cylindrical. In other implementations, the rod 104 may have a different shape, such as a cubic shape. The rod 104 may have a second orientation that is perpendicular to the first orientation of the rectangular handle 102. For example, as depicted in FIG. 1, the rod 102 may have a vertical orientation. The rod 104 may have a second length 124 that is greater than a first length 122 of the rectangular handle 102. As a non-limiting example, the first length 122 of the rectangular handle 102 may be equal to 4 inches, and the second length 124 of the rod may be equal to 15.875 inches. It should be understood that the dimensions described herein are merely for illustrative purposes and that, in other implementations, the tool 100 may have different dimensions. Non-limiting examples of the tool 100 having different dimensions are described below with respect to FIG. 2. In some implementations, the rod 104 may be comprised of steel or any other sturdy material, such as iron, copper, plastic, etc.

The tool 100 also includes a U-shaped component 106 attached to a second end of the rod 104. In some scenarios, the U-shaped component 106 may be attached to the rod 104 via a welding process. Optionally, the U-shaped component 106 may include a rectangular support component 107 to increase a sturdiness of the tool 100 when pressure is applied to remove rubber protectors from riser flanges. The second end of the rod 104 may be attached to the rectangular support component 107 of the U-shaped component 106. The U-shaped component 106 (including the rectangular support component 107) may be comprised of steel or any other sturdy material, such as iron, copper, plastic, etc. In some implementations, the rectangular support component 107 has a width of 1.5 inches. In some implementations, the rectangular support component 107 has a length of 4.25 inches. In some implementations, a distance 130 between the rectangular handle 102 and a vertex of the U-shaped component 106 is equal to 17.375 inches. In some implementations, the U-shaped component 106 (including the rectangular support component 107) has a height 134 of 9.625 inches., while the U-shaped component 106 has a height 132 of 6 inches. It should be understood that the dimensions described herein are merely for illustrative purposes and that, in other implementations, the U-shaped component 106 may have different dimensions. Non-limiting examples of the U-shaped component 106 having different dimensions are described below with respect to FIG. 2.

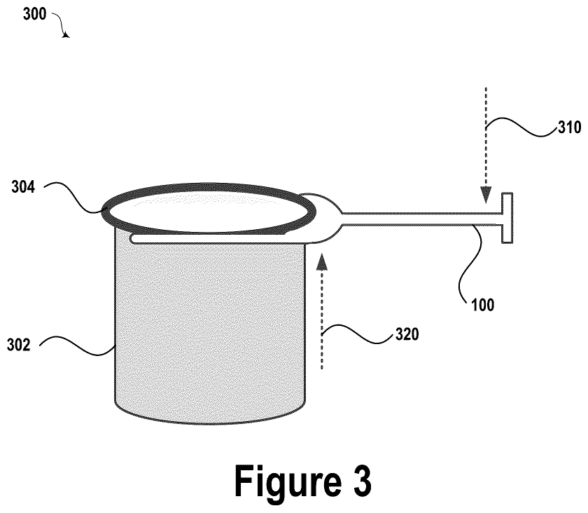

The U-shaped component 106 may be configured to grasp at least a portion of the rubber protector, as described and illustrated with respect to FIGS. 3-5. In response to a first force applied to the rectangular handle 122, the U-shaped component 106 may be configured to apply a second force to the portion of the rubber protector to remove the rubber protector from the riser flange, as described and illustrated in greater detail with respect to FIGS. 3-5.

A thickness of the U-shaped component 106 enables portions of the U-shaped bar to fit between the rubber protector and the riser flange. According to one implementation, the U-shaped component 106 may be 0.125 inches thick. To grasp at least the portion of the rubber protector, a first side of the U-shaped component 106 fits between a first side of the rubber protector and the riser flange, a second side of the U-shaped component 106 fits between a second side of the rubber protector and the riser flange. According to one implementation, the first side of the U-shaped component 106 has a first width 150 that is equal to 0.75 inches, and the second side of the U-shaped component 106 has a second width that is equal to 0.75 inches. According to one implementation, a distance 154 between the first side of the U-shaped component 106 and the second side of the U-shaped component 106 may be equal to 4.125 inches. It should be understood that the dimensions described herein are merely for illustrative purposes and that, in other implementations, the U-shaped component 106 may have different dimensions. Non-limiting examples of the U-shaped component 106 having different dimensions are described below with respect to FIG. 2. In some implementations, the distance 154 between the first side of the U-shaped component 106 and the second side of the U-shaped component 106 is adjustable.

According to one implementation, a height 118 of the tool 100 may be equal to 23.5 inches. However, it should be understood that the dimensions described herein are merely for illustrative purposes and that, in other implementations, the tool 100 may have different dimensions.

The tool 100 may be used to efficiently remove rubber protectors from riser flanges. For example, instead of construction crews exerting large amounts of energy and time attempting to remove the rubber protectors from the riser flanges, the construction crew can use the tool 100 to remove the rubber protectors while exerting a fraction of the energy and in a fraction of the time.

FIG. 2 illustrates tools, having different dimensions, that are operable to remove a rubber protector from a riser flange. For example, in FIG. 2, a tool 100A may have first dimensions, a tool 100B may have second dimensions that are different than the first dimensions, and a tool 100C may have third dimensions that are different than the first and second dimensions. In some implementations, a single tool 100 can have adjustable settings so that the single tool 100 can have the dimensions of each tool 100A, 100B, 100C in FIG. 2.

The tool 100A may have a first distance 200A between the sides of the U-shaped component. As a non-limiting example, the first distance 200A between the sides of the U-shaped component of the tool 100A may be equal to 4.125 inches. The tool 100B may have a second distance 200B between the sides of the U-shaped component. As a non-limiting example, the second distance 200B between the sides of the U-shaped component of the tool 100B may be equal to 4.375 inches. The tool 100C may have a third distance 200C between the sides of the U-shaped component. As a non-limiting example, the third distance 200C between the sides of the U-shaped component of the tool 100C may be equal to 6.375 inches.

It should be appreciated that the different distances 200A, 200B, 200C (e.g., the different dimensions) enable the tools 100A, 100B, 100C to remove rubber protectors from riser flanges having different sizes.

FIG. 3 illustrates a diagram 300 of a tool removing a rubber protector from a riser flange. In FIG. 3, the U-shaped component 106 of the tool 100 is grasping at least a portion of rubber protector 304 inserted in a riser flange 302. A first force 310 (e.g., a downward force) is applied to the rectangular handle 102 of the tool 100. In response to the first force 310, the U-shaped component 306 of the tool 100 applies a second force 320 (e.g., an upward force) to the rubber protector 304 to remove the rubber protector 304 from the riser flange 302.

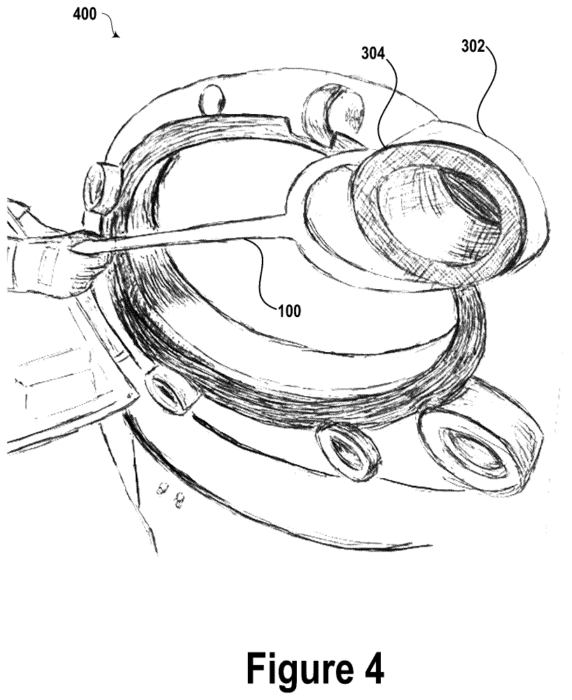

FIG. 4 illustrates a first step 400 for removing a rubber protector from a riser flange with a tool. For example, in FIG. 4, the U-shaped component 106 of the tool 100 is grasping at least a portion of rubber protector 304 inserted in a riser flange 302. A downward force is applied to the rectangular handle 102 of the tool 100. In response to the downward force, the U-shaped component 306 of the tool 100 applies an upward force to the rubber protector 304 to remove the rubber protector 304 from the riser flange 302.

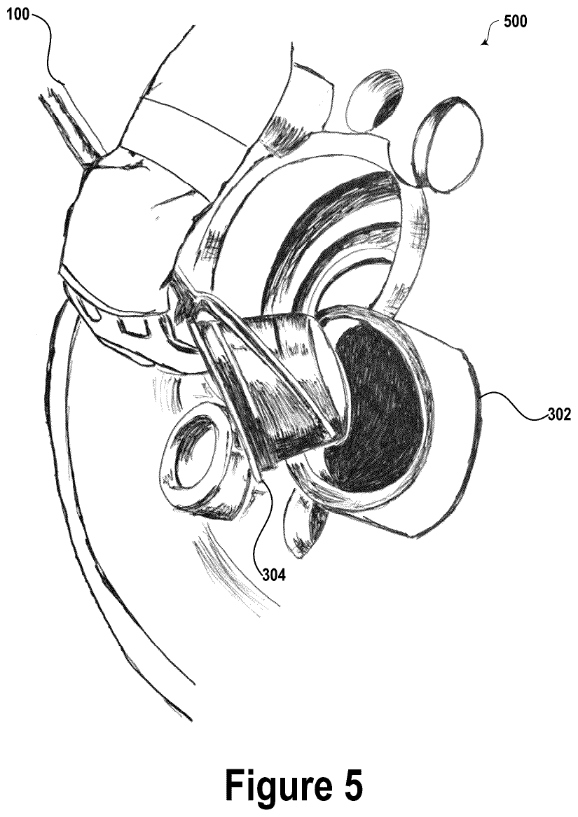

FIG. 5 illustrates a second step for removing a rubber protector from a riser flange with the tool. For example, in FIG. 5, the upward force applied by the U-shaped component 306 of the tool removed the rubber protector 304 from the riser flange 302.

The techniques described with respect to FIGS. 3-5 enable efficient removal of the rubber protectors 304 from riser flanges 302. For example, instead of construction crews exerting large amounts of energy and time attempting to remove the rubber protectors 304 from the riser flanges 302, the construction crew can use the tool 100 described herein to remove the rubber protectors 304 while exerting a fraction of the energy and in a fraction of the time.

The illustrations of the examples described herein are intended to provide a general understanding of the structure of the various implementations. The illustrations are not intended to serve as a complete description of all of the elements and features of apparatus and systems that utilize the structures or methods described herein. Many other implementations may be apparent to those of skill in the art upon reviewing the disclosure. Other implementations may be utilized and derived from the disclosure, such that structural and logical substitutions and changes may be made without departing from the scope of the disclosure. For example, method operations may be performed in a different order than shown in the figures or one or more method operations may be omitted. Accordingly, the disclosure and the figures are to be regarded as illustrative rather than restrictive.

Moreover, although specific examples have been illustrated and described herein, it should be appreciated that any subsequent arrangement designed to achieve the same or similar results may be substituted for the specific implementations shown. This disclosure is intended to cover any and all subsequent adaptations or variations of various implementations. Combinations of the above implementations, and other implementations not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single implementation for the purpose of streamlining the disclosure. Examples described above illustrate but do not limit the disclosure. It should also be understood that numerous modifications and variations are possible in accordance with the principles of the present disclosure. As the following claims reflect, the claimed subject matter may be directed to less than all of the features of any of the disclosed examples. Accordingly, the scope of the disclosure is defined by the following claims and their equivalents.

What is claimed is:

1. A tool for removing a rubber protector from a riser flange, the tool comprising:
a rectangular handle having a first orientation;
a rod having a first end that is attached to a midpoint of the rectangular handle, wherein the rod has a second orientation that is perpendicular to the first orientation of the rectangular handle, and wherein the rod has a second length that is greater than a first length of the rectangular handle; and
a U-shaped component attached to a second end of the rod, wherein the U-shaped component is configured to:
grasp at least a portion of the rubber protector; and
in response to a first force applied to the rectangular handle, apply a second force to the portion of the rubber protector to remove the rubber protector from the riser flange.

2. The tool of claim 1, wherein the rectangular handle, the rod, and the U-shaped component are comprised of steel.

3. The tool of claim 1, wherein a thickness of the U-shaped component enables portions of the U-shaped component to fit between the rubber protector and the riser flange.

4. The tool of claim 1, wherein the U-shaped component includes a rectangular support component, and wherein the second end of the rod is attached to the rectangular support component of the U-shaped component.

5. The tool of claim 4, wherein the rectangular support component is comprised of steel.

6. The tool of claim 4, wherein the rectangular support component has a width of 1.5 inches.

7. The tool of claim 4, wherein the rectangular support component has a length of 4.25 inches.

8. The tool of claim 1, wherein, to grasp at least the portion of the rubber protector:
a first side of the U-shaped component fits between a first side of the rubber protector and the riser flange; and
a second side of the U-shaped component fits between a second side of the rubber protector and the riser flange.

9. The tool of claim 8, wherein the first side of the U-shaped component has a first width that is equal to 0.75 inches, and wherein the second side of the U-shaped component has a second width that is equal to 0.75 inches.

10. The tool of claim 9, wherein a distance between the first side of the U-shaped component and the second side of the U-shaped component is equal to 4.125 inches.

11. The tool of claim 9, wherein a distance between the first side of the U-shaped component and the second side of the U-shaped component is adjustable.

12. The tool of claim 1, wherein the first length of the rectangular handle is equal to 4 inches, and wherein the second length of the rod is equal to 15.875 inches.

13. The tool of claim 1, wherein a distance between the rectangular handle and a vertex portion of the U-shaped component is equal to 17.375 inches.
